(19) United States
(12) Patent Application Publication
(10) Pub. No.: US 2019/0386422 A1
(43) Pub. Date: Dec. 19, 2019

(54) CONNECTOR CONNECTION STRUCTURE

(71) Applicants: Yazaki Corporation, Tokyo (JP); AISIN AW CO., LTD., Aichi-ken (JP)

(72) Inventors: Kenji Takahashi, Shizuoka (JP); Akira Sato, Shizuoka (JP); Kiyotaka Mizuno, Shizuoka (JP); Takahiro Sugiyama, Shizuoka (JP); Teruo Kato, Aichi-ken (JP); Riku Kambe, Aichi-ken (JP)

(21) Appl. No.: 16/417,568

(22) Filed: May 20, 2019

(30) Foreign Application Priority Data
Jun. 19, 2018 (JP) 2018-116058

(51) Int. Cl. H01R 13/52; H01R 13/74; H01R 31/06; H02K 5/12

(52) U.S. Cl. CPC H01R 13/521; H01R 13/74; H02K 5/12; H01R 31/06; H01R 13/5202

(57) ABSTRACT

A connector connecting structure can block liquid leakage outside a liquid-filled case and reduce the size of the device including a number of elements and a liquid sealed case and the number of electrical connection points. A connector connecting structure is provided with a connector AT connector (first connector) fixed to an AT case, an ECU connector (second connector) connected to the AT connector (first connector), a first sealing member sealing a space between the AT case (liquid sealed case) and the AT connector (first connector), and a second sealing member sealing a space between an ECU side housing (second housing) and a male-type terminal (second terminal).

### BACKGROUND OF THE INVENTION

### Field of the Invention

The present invention relates to a connector connecting structure for electrically connecting an internal device of a liquid-filled case to an external device.

### Description of the Related Art

Conventionally, in an automatic transmission of a vehicle, lubricating oil for a transmission is, in many cases, sealed inside the case together with an internal device such as a transmission and various sensors. The automatic transmission is connected to an external device and receives its operation control. Then, there has been proposed a connector connecting structure for electrically connecting the internal device of the automatic transmission to an external device while preventing oil leakage to outside of the case (See, for example, Patent Literature 1).

In the connector connecting structure described in Patent Literature 1, a connector provided at an end portion of an electric wire coming from the internal device and a connector fixed to a case of the external device are connected to the case of the automatic transmission via a relay connector fixed to the automatic transmission. Then, provision of various sealing members with the relay connector prevents oil leakage to the outside of the case of the automatic transmission.

### CITATION LIST

### Patent Literature

Patent Literature 1: Japanese Patent Application Laid-Open No. 11-111382

### SUMMARY OF THE INVENTION

Here, with the above-described connector connecting structure using the relay connector, there is room for improvement in terms of a number of parts, a size of the automatic transmission, a number of electrical connection points, and the like.

Note that the fact that there is room for improvement has been explained here taking the connector connecting structure for the automatic transmission in which lubricating oil is filled in the case as an example. However, such cases are not limited to the connector connecting structure for the automatic transmission, and may generally occur as far as a connector connecting structure for electrically connecting an internal device of a liquid-filled case to an external device.

Accordingly, the present invention focuses on the room for improvement as described above, and aims at providing a connector connecting structure capable of suppressing the number of parts, the size of an apparatus having the liquid-filled case, and the number of the electrical connection points, while preventing oil leakage to the outside of the liquid-filled case.

In order to solve the above-mentioned problem, a connector connecting structure of the present invention, which is for electrically connecting an internal device having a liquid-filled case to an external device, includes: a first connector including a first terminal accommodated in a first housing, provided at an end of an electric wire coming from the internal device, and fixed to the liquid-filled case; a second connector including a second terminal accommodated in a second housing, provided at an end of the electric wire coming from the external device or fixed to a case of the external device, and connected to the first connector; a first sealing member for sealing a space between the liquid-filled case and the first connector; and a second sealing member for sealing a space between the second housing and the second terminal in the second connector.

In the connector connecting structure of the present invention, the first connector provided at the end portion of the electric wire from the internal device and secured to the liquid-filled case is connected to the second connector provided at the end of the wire from the external device or to be fixed to the case of the external device. In other words, according to the connector connecting structure of the present invention, the number of connectors involved in the connection can be reduced to two. Due to the above, compared with a connector connecting structure using the relay connector described above, the number of parts, the increase in the size of the device having the liquid-filled case, and the number of electrical connection points can be suppressed. Moreover, the first sealing member prevents liquid leakage from between the liquid-filled case and the first connector, the second sealing member prevents liquid leakage through the first terminal of the first connector and the second terminal of the second connector. As described above, according to the connector connecting structure of the present invention, the number of parts, the increasing in size of the apparatus having the liquid-filled case, and the number of connection points can be suppressed.

### BRIEF DESCRIPTION OF THE DRAWINGS

FIG. 1 is a schematic cross-sectional view showing a connector connecting structure according to a first embodiment of the present invention;

FIG. 2 is an enlarged view of a region A11 in FIG. 1;

FIG. 3 is an enlarged view of a region A12 in FIG. 1;

FIG. 4 is a view showing a connector connecting of a comparative example to the connector connecting structure shown in FIGS. 1 to 3;

FIG. 5 is a schematic cross-sectional view showing a connector connecting structure according to a second embodiment of the present invention;

FIG. 6 is an enlarged view of a region A21 in FIG. 5;

FIG. 7 is a view showing a comparative example connector connecting structure with the connector connecting structure shown in FIGS. 5 and 6;

FIG. 8 is a schematic cross-sectional view showing a connector connecting structure according to a third embodiment of the present invention; and

FIG. 9 is an enlarged view of a region A31 in FIG. 8.

### DETAILED DESCRIPTION OF THE PREFERRED EMBODIMENTS

Hereinafter, an embodiment of the present invention will be described. First, a first embodiment will be described.

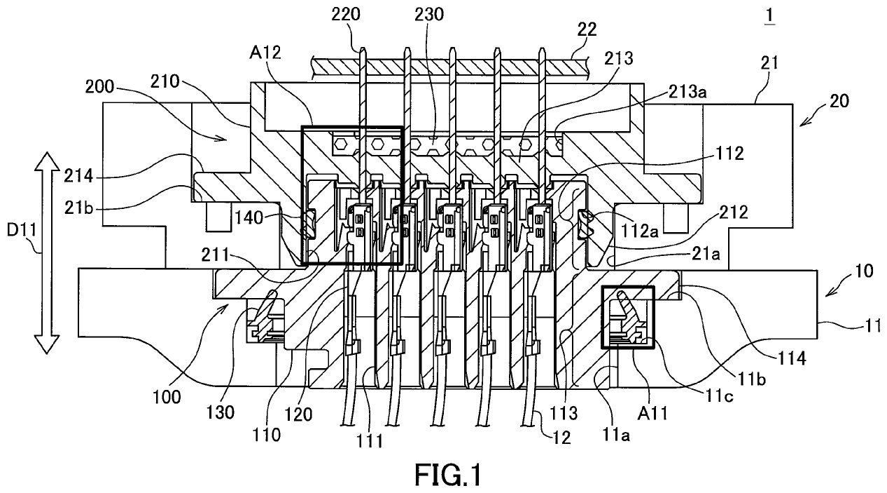

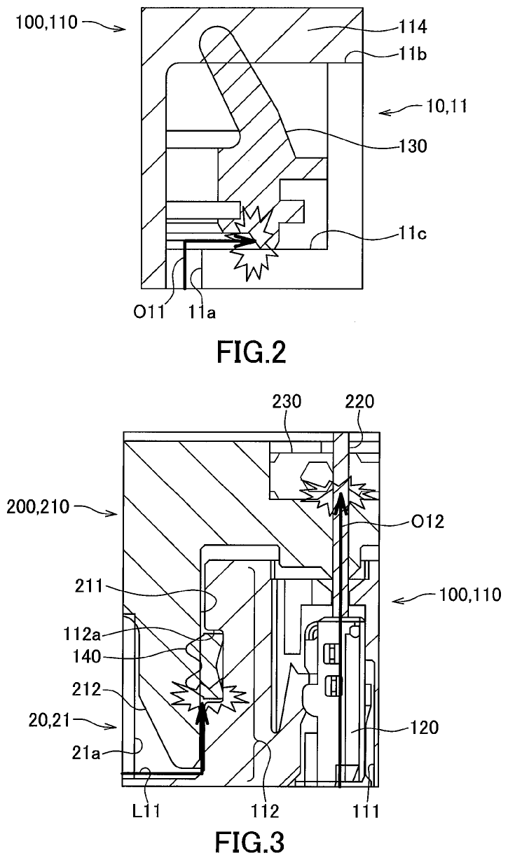

FIG. 1 is a schematic cross-sectional view showing a connector connecting structure according to the first embodiment of the present invention. FIG. 2 is an enlarged view of a region A11 in FIG. 1, and FIG. 3 is an enlarged view of a region A12 in FIG. 1.

This connector connecting structure 1 connects an internal device such as various sensors in a vehicle automatic transmission (AT) to an ECU (Engine Control Unit) 20 for controlling the AT10. The AT10 has lubricating oil for a transmission device along with the transmission device and an internal device such as various sensors inside of T case 11 (liquid-filled case). The connector connecting structure 1 prevents oil from leaking from the AT case 11 and connects the internal device to the ECU 20 (external device).

The connector connecting structure 1 includes an AT connector 100 (first connector), and an ECU connector 200 (second connector).

The AT connector 100 is provided at an end of the electric wire 12 coming from the internal device of the AT case 11 as well as fixed to the AT case 11. An opening 11a is provided in the AT case 11, and the AT connector 100 is fixed so as to close the opening 11a. On the other hand, the ECU connector 200 is connected to a circuit board 22 built in the ECU 20, and is fixed to the ECU case 21 constituting the ECU 20. The ECU case 21 is also provided with an opening 21a and the ECU connector 200 is fixed so as to close the opening 21a.

In the present embodiment, the ECU connector 200 is detachably connected to the AT connector 100 together with the ECU 20 in a connecting direction D11 in the figure.

The AT connector 100 has a plurality of contacts (not shown) provided in an AT side housing 110 (first housing) accommodate a plurality of female type terminals 120 (first terminal) to which each is press-fitted to end portions of the electric wires 120. The AT side housing 110 is provided with a protrusion 112 serving as a portion so as to enter the ECU connector 200 in the AT connector 100. An inlet for a female type terminal 120 is opened on a side of the ECU connector 200 in this protrusion 112 in communication with the terminal accommodating chamber 11.

In addition, the AT side housing 110 is provided with a fixing flange 114 for fixing the AT connector 100 to the T case 11 with the aforementioned protrusion 112 protruding from the AT case 11 to the outside and the other part 113 entering the AT case 11. At the AT case 11, an edge of the opening 11a on the outer surface side of the case is recessed stepwise from the outer surface of the case in two steps. Then, the AT connector 100 is inserted into the opening 11a from the outside of the AT case 11, and fixing flange 114 is fixed to a first step portion 11b so that the fixing flange 114 comes into contact with the first step portion 11b positioned on the outer surface side of the case.

The ECU connector 200 is the one in which the ECU side housing 210 (second housing) is provided with a plurality of male type terminals 220 (second terminal). The ECU side housing 210 is provided with a recess 211 for receiving the protrusion 112 of the AT connector 100. A pin-shaped male type terminal 220 is attached passing through a bottom wall 213 of this recess 211. A side opposite to the AT connector 100 in the male type terminal 220 is soldered to a circuit board 22 inside the ECU 20. When the protrusion 112 of the AT connector 100 enters the recess 211 of the ECU connector 200, the male type terminal 220 enters from a terminal insertion port of the end face of the protrusion 112 and is connected to the female type terminal 120.

Further, the ECU side housing 210 is provided with a fixing flange 214 for fixing the ECU connector 200 to the ECU case 21, with a cylindrical portion 212 provided with the recess 211 accommodated inside the opening 21a. Then, the ECU connector 200 is inserted into the opening 21a from the inside of the ECU case 21, and the fixing flange 214 is fixed to the wall surface 21b so that the fixing flange 214 abuts onto a peripheral wall surface 21b on a case inner surface side of the opening 21a in the ECU case 21.

Here, in the connector connecting structure 1 of the present embodiment, a first sealing member 130 and a second sealing member 230, which will be described below, are provided for preventing oil leakage from the AT case 11.

The first sealing member 130 is a gasket made of resin for sealing a space between the AT connector 100 and the AT case 11. This first sealing member 130 is formed in a ring shape and attached at a position closer to the inside of the AT case 11 than the fixing flange 114 in the AT side housing 110 of the AT connector 100 so as to surround the outer peripheral surface of the AT side housing 110. The AT connector 100 is inserted from outside into the opening 11a of the AT case 11 and fixed to a first step portion 11b. Then, the first sealing member 130 is, while adhering to each of a second step portion 11c further lowered inward from the first step portion 11b and the fixing flange 114, sandwiched therebetween. As a result, the first sealing member 130 hermetically seals the space between the AT connector 100 and the AT case 11. As shown in FIG. 2, this first sealing member 130 blocks the oil O11 from progressing from an inside of the AT case 11 coming along a pace between the inner periphery of the opening 11a and an outer periphery of the AT connector 10. This blocking prevents oil leakage from the space between the AT connector 100 and the AT case 11.

The second sealing member 230 is resin filler that seals a space between the ECU side housing 210 and the male terminals 220 in the ECU connector 200. The opposite side of the AT connector 100 at the bottom wall 213 of the recess 211 for receiving the projection 112 of the AT connector 100 in the ECU side housing 210 is provided with a recess 213 including attachment points of a plurality of male type terminals 220. The second sealing member 230 is filled in the recess 213a with adhering to each of a part of the outer surface and the inner surface of the recess 213a of each of the male type terminals 220, that is, the inner wall surface of the ECU side housing 210. As a result of such filling, the second sealing member 230 hermetically seals the space between the ECU side housing 210 and the male type terminal 220. As shown in FIG. 3, the second sealing member 230 blocks the oil O12 from progressing from the inside of the AT case 11 coming along the female type terminal 120 of the connector 100 and the male type terminal 220 of the ECU connector 200. This blocking prevents oil from leaking along these terminals into the ECU case 21.

Here, in the present embodiment, a third sealing member 140 is provided so as to surround the outer peripheral surface of the protrusion 112 of the AT side housing 110 of the AT connector 100. This third sealing member 140 is a ring-shaped packing made of resin for sealing a space between the AT connector 100 and the ECU connector 200.

A recess groove 112a is provided on the outer peripheral surface of the above-mentioned protrusion 112 around its periphery in the peripheral direction, and the third ring-shaped sealing member 140 is fitted in the recess groove 112a. When the protrusion 112 of the AT connector 100 enters the recess 211 of the ECU connector 200, the third sealing member 140 is sandwiched between the outer peripheral surface of the protrusion 112 and the inner peripheral surface of the recess 211 while adhering closely to each of them. As a result, the third sealing member 140 hermetically seals the space between the AT connector 100 and the ECU connector 200. As shown in FIG. 3, this third sealing member 140 blocks liquid L11 such as water coming along from the outside of the space between the AT case 11 and the ECU case 21 from progressing. This blocking prevents external liquid from entry into the AT case 11 and the ECU case 21.

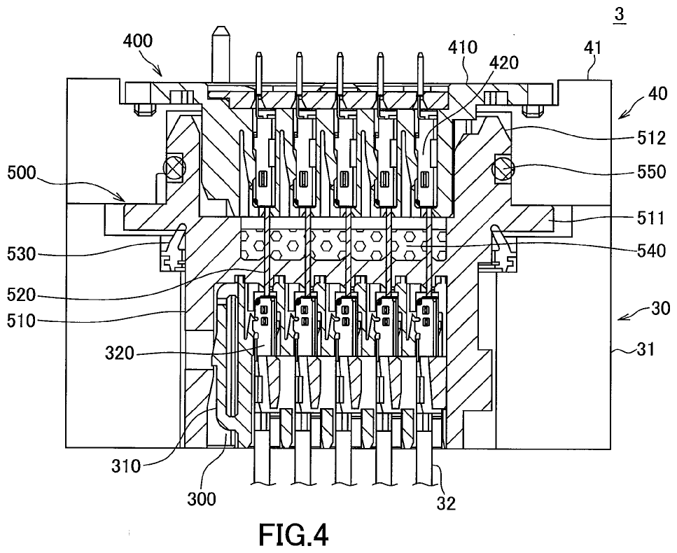

FIG. 4 is a view of a connector connecting structure of a comparative example to the connector connecting structure shown in FIGS. 1 to 3.

The connector connecting structure 3 of this comparative example includes an AT connector 300, an ECU connector 400, as well as a relay connector 500. The AT connector 300 in this comparative example, is provided at an end portion of the electric wire 32 coming from the internal device of an AT case 31 in an AT30, but is not fixed to the AT case 31 and connected to the relay connector 500. This relay connector 500 is fixed to the AT case 31. The ECU connector 400 is fixed to the ECU case 41 in an ECU 40.

In the connector connecting structure 3 of this comparative example, the relay connector 500 is the one in which a pin-like male type terminal 520 whose end portion protrudes toward both the AT connector 300 and the ECU connector 400 are attached to the housing 510. Then, the AT connector 300 is the one in which the female type terminal 320 to be connected to the male type terminal 520 is accommodated in an AT side housing 310. Similarly, the ECU connector 400 is also the one in which a female type terminal 420 connected to the male type terminal 520 of the relay connector 500 is accommodated in an ECU side housing 410.

In the connector connecting structure 3 of the comparative example, the relay connector 500 is provided with a first sealing member 530 and a second sealing member 540 for preventing oil leakage from the AT case 31. The first sealing member 530 is a ring-shaped gasket made of resin, and is, with adhering to each of the fixing flange 511 for fixing the relay connector 500 to the case 31 and the AT case 31, sandwiched therebetween. The second sealing member 540 is a resin-made filling material, and is filled in the relay housing 510 while adhering to each of an inner wall surface of the male type terminal 520 and the relay housing 510. The first sealing member 530 seals a space between the AT case 31 and the relay connector 500 and prevents oil leakage from therebetween. Further, the second sealing member 540 prevents oil from infiltrating into the ECU case 41 via the female type terminal 320 of the AT connector 300 and the male type terminal 520 of the relay connector 500.

Furthermore, in the connector connecting structure 3 of the comparative example, the relay connector 500 is provided with a third sealing member 550 for preventing liquid such as water and the like from entering from the outside. The third sealing member 550 is a ring shaped gasket made of resin and is attached surrounding the outer peripheral surface of the protrusion 512 which enters the inside of the ECU case 41 in the relay housing 510. When the protrusion 512 enters the inside of the ECU case 41, the third sealing member 550 is, while adhering to each of the outer peripheral surface of the protrusion 512 and the inner wall surface of the ECU case 41, sandwiched therebetween. As a result, a space between the relay connector 500 and the ECU case 41 is hermetically sealed, preventing entry of the external liquid from outside.

In the connector connecting structure 3 of the comparative example described above, the number of parts increases due to usage of the relay connector 500. Also, requirement to provide not only the accommodation space for the AT connector 300 but also the mounting space for the relay connector 500 in the AT case 31 induces increase in size of the AT30. Furthermore, since the AT connector 300 and the ECU connector 400 are electrically connected via the relay connector 500, there are many electrical connection points. Such connection points are desired to be less in view of the probability of occurrence of electrical connection failure.

On the other hand, in the connector connecting structure 1 of the first embodiment shown in FIGS. 1 to 3, the ECU connector 200 is connected to the AT connector 100. That is, according to the connector connecting structure of this embodiment, the number of connectors related to connection can be reduced to two. As a result, compared to the connector connecting structure 3 of the comparative example using the relay connector 500, the number of parts, the increasing in size of the AT 10, and the number of electrical connection points can be suppressed. In addition, the first sealing member 130 prevents oil leakage from the space between the AT case 11 and the AT connector 100. Also, the second sealing member 230 prevents oil leakage into the ECU 20 via the female type terminal 120 of the AT connector 100 and the male type terminal 220 of the ECU connector 200. Thus, according to the connector connecting structure 1 of the present embodiment, the oil leakage to the outside of the AT case 11 can be prevented while the number of parts, the increase in size of the apparatus having the liquid-filled case, and the number of the electrical connection points can be suppressed.

Further, in the present embodiment, the AT connector 100 is provided with a fixing flange 114, the first sealing member 130 is, while adhering to each of the AT case 11 and the fixing flange 114, sandwiched therebetween. Thereby, a simple structure that the AT case 11 and the fixing flange 114 sandwich the first sealing member 130 can hermetically seal the space therebetween, reducing manufacturing cost.

Further, in the present embodiment, the second sealing member 230 is, while keeping close contact with each of the part of the outer peripheral of the male type terminal 220 of the ECU connector 200 and the inner wall surface of the ECU side housing 210, filled in the ECU side housing 210. Also in this point, since a simple structure of filling the sealing member 230 can seal the space therebetween, manufacturing cost can be reduced.

Further, in the present embodiment, the third sealing member 140 sealing the space between the AT connector 100 and the ECU connector 200 is provided. As described above, the third sealing member 140 is, while adhering to the outer peripheral surface of the protrusion 112 of the connector 100 and the inner peripheral surface of the recess 211 of the ECU connector 200, sandwiched therebetween. Provision of this third sealing member 140 can prevent liquid such as water from entering from the space between the AT connector 100 and the ECU connector 200.

Further, in the present embodiment, the ECU connector 200 is fixed to the ECU case 21. As a result, increase in size of the entire assembled body to which the ECU 20 is externally attached to the AT case 11 can be suppressed.

Further, in the present embodiment, the terminal of the AT connector 100 is the female type terminal 120, the ECU connector terminal 200 is the male type terminal 220. Making the terminal of the ECU connector 200 to be a simpler shape of male type terminal 220 than the female type terminal 120 can easily seal the space spaced from the ECU side housing 210 by the second sealing member 230.

Next, a second embodiment will be described. In this second embodiment, provision of further sealing member is different from those of the above-described first embodiment. Hereinafter, with regard to the second embodiment, this difference is focused and explained.

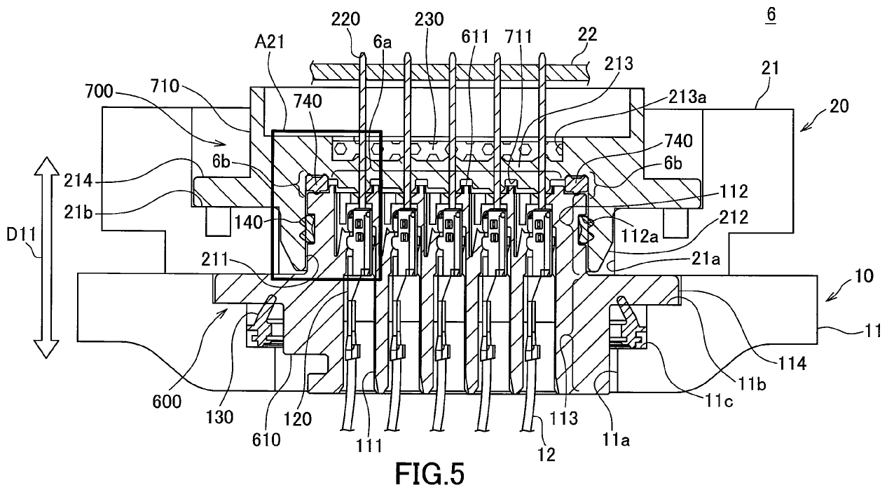

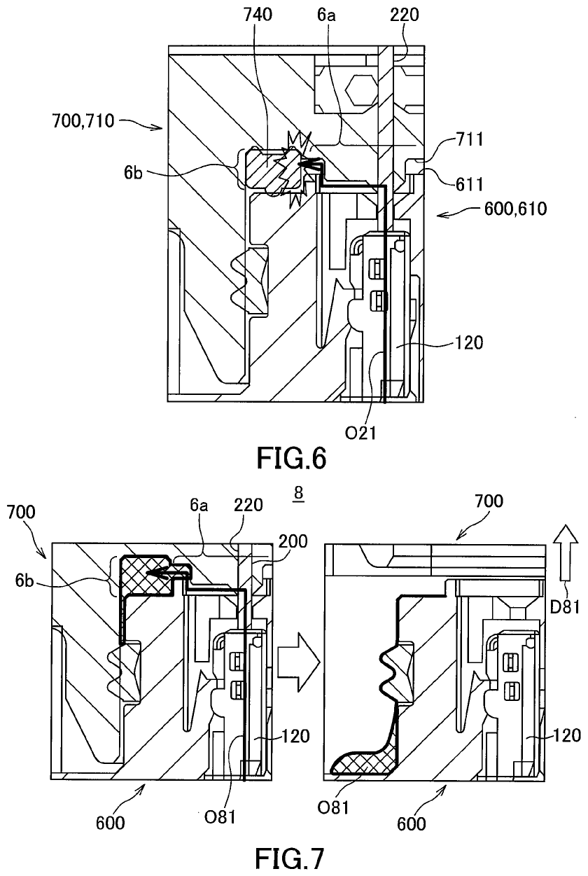

FIG. 5 is a schematic cross-sectional view showing a connector connecting structure according to the second embodiment of the present invention. FIG. 6 is an enlarged view of a region A21 in FIG. 5. In FIGS. 5 and 6 the same reference numerals denote the same constituent elements as those in FIGS. 1 to 3 for those of the constituent elements of the first embodiment, and in the following description, duplicate descriptions of these equivalent elements will be omitted.

In the connector connecting structure 6 of the second embodiment, first, similarly to the connection structure 1 of the connector of the aforementioned first embodiment, the number of connectors involved in connection is suppressed to two of the AT connector 600 and the ECU connector 700. The first sealing member 130 attached to the AT side housing 610 (first housing) of the AT side connector 600 prevents oil leakage from between the AT connector 600 and the AT case 11. Also, the second sealing member 230 filled in the ECU side housing 710 (second housing) in the ECU connector 700 prevents oil leakage into the ECU 20 via the female type terminal 120 of the AT connector 600 and the male type terminal 2 of the ECU connector 700. Furthermore, the third sealing member 140 prevents oil infiltration such as water coming from the outside between the AT connector 600 and the ECU connector 700.

As described above, the connector connecting structure 6 of the second embodiment, similarly to the first embodiment, also while preventing oil leakage to the outside of the AT case 11, can suppress the number of parts, increase in size of the device equipped with the liquid-filled case, and the number of electrical connection points.

Here, the connector connecting structure 6 of the second embodiment adapts labyrinth structure to be described below in a region 6a where the respective terminals are connected in a boundary of the AT connectors 600 and the ECU connector 700.

That is, on the side of the AT connector 600 in the terminal connection region 6a, an opening of the terminal accommodating chamber 111 at the AT side housing 610 is surrounded by the labyrinth ribs 611 protruding toward the ECU connector 700. On the ECU connector 700 side in the terminal connection region 6a, the ECU side housing 710 is provided with a labyrinth recess 711 into which labyrinth rib 611 enters. The labyrinth rib 611 connects the AT connector 600 and the ECU connector 700 such that the labyrinth rib 611 enters the labyrinth recess 711, and whereby the labyrinth structure terminal connection region 6a is formed of which cross-sectional shape is formed in a serpentine shape as shown in FIG. 5. The terminal connection region 6a with such a labyrinth structure suppresses entry of foreign matter or the like into the connection area 6a.

Here, adapting the labyrinth structure allows a wider annular gap 6b to be formed between the AT connector 600 and the ECU connector 700 peripherally surrounding the terminal connection region 6a. In the present embodiment, a fourth sealing member 740 is provided so as to fill the annular gap 6b.

The fourth sealing member 740 is disposed surrounded by both the AT connector 600 and the ECU connector 700 while adhering thereto so as to surround the terminal connection region 6a. Then, as shown in FIG. 6, oil O21 inside the AT case 11, when flowing to the terminal connection region 6a along the female type terminal 120 of the AT connector 600 and the male type terminal 220 of the ECU connector 700, is blocked from progressing to the outer peripheral surface. The fourth sealing member 740 is fitted in the bottom of the recess 211 in the ECU side housing 710.

FIG. 7 is a view showing a connector connecting of a comparative example to the connector connecting structure shown in FIGS. 5 and 6.

The connector connecting structure 8 of the comparative example shown in FIG. 7 has the same structure as the connector connecting structure 6 shown in FIGS. 5 and 6 except that no fourth sealing member 740 shown in FIGS. 5 and 6 is provided. In FIG. 7, the same elements as those shown in FIGS. 5 and 6 denote the same reference numerals as in FIG. 5 and FIG. 6, and duplicate descriptions of these equivalent elements in the following will be omitted.

In the connector connecting structure 8 of this comparative example, oil O81 flowing along the female type terminals 120 of the AT connector 600 and the male type terminal 220 of the ECU connector 700 to the terminal connection region 6a is accumulated in an annular gap 6b surrounding the terminal connection region 6a. Therefore, when the ECU connector 700 is moved to the arrow D81, the accumulated oil O81 may flow down to the outer periphery of the AT connector 600 and diffuse to the surroundings.

On the other hand, according to the above-described connector connecting structure 6 of the second embodiment, the oil O21 flowing to the terminal connection region 6a from the AT case 11 is blocked from progressing by the fourth sealing member 740. As a result, when the ECU connector 700 is removed, the oil O21 can be prevented from being situations such as flowing down to the outer peripheral surface of the AT connector 600 and diffusing to the surroundings.

Next, a third embodiment will be described. This third embodiment is a modified example above-described and different from the second embodiment in the blocking method for the oil O21 flowing to the terminal connection region 6a. Hereinafter, with respect to the third embodiment, this difference will be attended and explained.

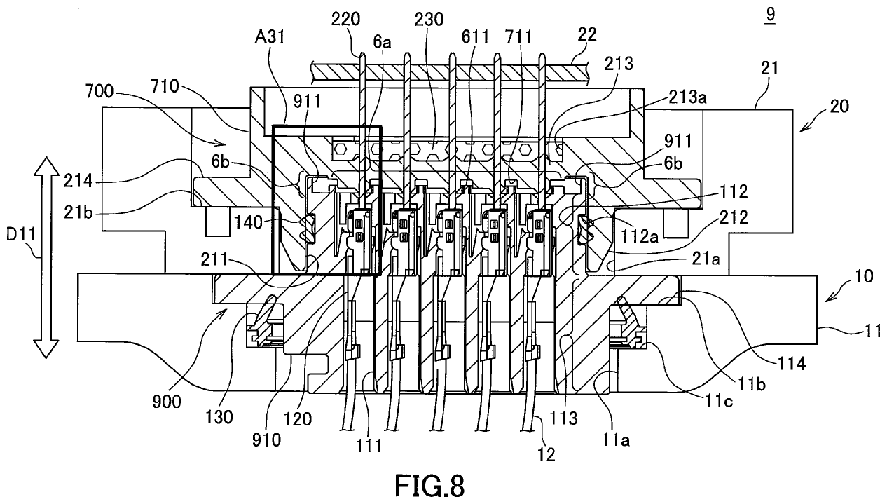

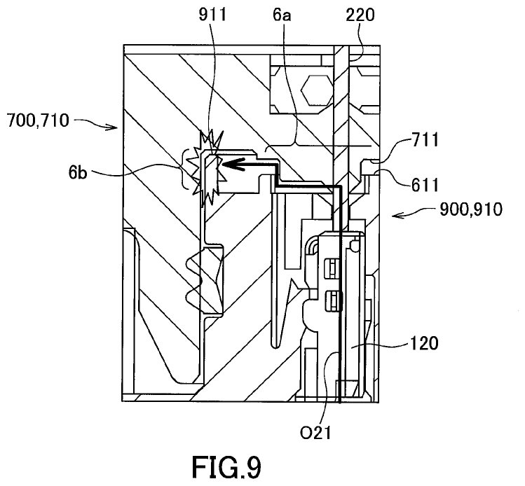

FIG. 8 is a schematic cross-sectional view showing a connector connecting structure according to a third embodiment of the present invention. FIG. 9 is an enlarged view of a region A 31 in FIG. 8. In FIGS. 8 and 9, the same constituent elements as those of the second embodiment shown FIGS. 5 and 6 denote the same reference numerals as those in FIGS. 5 and 6, and in the following description duplicate descriptions of these equivalent elements will be omitted.

Also in the connector connecting structure 9 of the third embodiment, similarly to the second embodiment shown in FIGS. 5 and 6, labyrinth structure is adapted in the terminal connection region 6a. Adapting the labyrinth structure can allow an annular gap 6b to be formed between the AT connector 900 and the ECU connector 700 so as to surround the terminal connection region 6a in the peripheral direction.

In the present embodiment, a blocking rib 911 for blocking at the annular gap 6b oil O21 flowing down from the inside of the AT case 11 along the female type terminal 120 of the AT connector 900 and the male type terminal 220 of the ECU connector 700 to the terminal connection region 6a.

The blocking rib 911 is erected in annular shape in the AT side housing 910 (first housing) at the AT connector 900 along the outer edge of the annular gap 6b so as to surround the terminal connection region 6a. As shown in FIG. 9, the blocking rib 911 blocks the oil O21 flowing from the AT case 11 to the terminal connection region 6a from progressing to the outer peripheral surface at the outer edge of the annular gap 6b.

First, also in the connector connecting structure 9 of the third embodiment, the same structure as in the second embodiment, needless to say, while preventing oil leakage to the outside of the AT case 11, suppress the number of elements, the increase in the size of the apparatus and the number of electrical connection points.

According to the third embodiment, the situation that when the ECU connector 700 is removed the Oil O21 flows down to the outer peripheral surface of the AT connector 900 and diffuses to the surroundings, etc. can be prevented by blocking the oil O21 by the rib 911.

It is to be noted that the first to third embodiments described above merely show representative embodiments of the present invention, the invention is not limited to this embodiment. That is, the invention can be variously modified in a range not deviating from the gist of the present invention. Even with such a deformation, as long as it involves the connector connecting structure of the present invention is of course included in the scope of the present invention.

For example, in the above-described first to third embodiments, as the example of the connector connecting structure according to the present invention, the connector connection structures 1, 6, and 9 are illustrated in which the internal devices such as various sensors in the AT10 of the vehicle to the ECU 20 are electrically connected to the ECU 10. However, the connector connecting structure according to the present invention is not limited to these, and its specific form is not inquired as far as those for electrically connecting the internal device of the liquid-filled case to the external device.

Further, in the first to third embodiments described above, as the example of the second connector according to the present invention, the ECU connectors 200, 700 fixed to the ECU case 21 are exemplified. However, the second connector according to the present invention is not limited to these, and it may alternatively be provided at the end of the electric wire from the external device.

### REFERENCE SIGNS LIST

1, 6, 9 connector connection structure
6a terminal connection area
6b annular gap
10 AT
11 AT case (liquid-filled case)
11a, 21a opening
11b first step portion
11c second step portion
12 electric wire
20 ECU (external device)
21 ECU case
21b surrounding wall
22 circuit board
100, 600, 900 AT connector (first connector)
110, 610, 910 AT side housing (first housing)
111 terminal housing
112 protrusion
112a groove
113 part
114,214 fixing flange
120 female type terminal
130 first sealing member
140 third sealing member
200, 700 ECU connector (second connector)
210, 710 ECU side housing (second housing)
211 recess
212 cylindrical part
213 bottom wall
213a recess
220 male type terminal
230 second sealing member
740 fourth sealing member
911 blocking rib
D11 connection direction
O11, O12, O21 oil
L11 liquid

What is claimed is:

1. A connector connecting structure for electrically connecting an internal device of a liquid-filled case to an external device, comprising:
a first connector including a first terminal accommodated in a first housing, provided at an end of an electric wire coming from the internal device, and fixed to the liquid-filled case;
a second connector including a second terminal accommodated in a second housing, provided at an end of the electric wire coming from the external device or fixed to a case of the external device, and connected to the first connector;
a first sealing member for sealing a space between the liquid-filled case and the first connector; and
a second sealing member for sealing a space between the second housing and the second terminal in the second connector.

2. The connector connecting structure according to claim 1, wherein
the first connector is provided with a fixing flange for fixing the first connector to the liquid-filled case with a part of the first connector entering the liquid-filled case, and wherein
the first sealing member is sandwiched by both the liquid-filled case and the fixing flange while in close contact with each of the liquid-filled case and the fixing flange.

3. The connector connecting structure according to claim 1, wherein
the second sealing member is filled inside the second housing while in close contact with each of a part of an outer surface of the second terminal of the second connector and an inner wall surface of the second housing of the second connector.

4. The connector connecting structure according to claim 2, wherein
the second sealing member is filled inside the second housing while in close contact with each of a part of an outer surface of the second terminal of the second connector and an inner wall surface of the second housing of the second connector.

5. The connector connecting structure according to claim 1, wherein
the first connector includes a protrusion that enters the second connector, and the second connector includes a recess for receiving the protrusion,
the connector connecting structure further comprising
a third sealing member for sealing a space between the first connector and the second connector by being sandwiched by both an outer peripheral surface of the protrusion and an inner peripheral surface of the recess while in close contact with each of the outer peripheral surface of the protrusion and the inner peripheral surface of the recess.

6. The connector connecting structure according to claim 2, wherein
the first connector includes a protrusion that enters the second connector, and the second connector includes a recess for receiving the protrusion,
the connector connecting structure further comprising
a third sealing member for sealing a space between the first connector and the second connector by being sandwiched by both an outer peripheral surface of the protrusion and an inner peripheral surface of the recess while in close contact with each of the outer peripheral surface of the protrusion and the inner peripheral surface of the recess.

7. The connector connecting structure according to claim 3, wherein
the first connector includes a protrusion that enters the second connector, and the second connector includes a recess for receiving the protrusion,
the connector connecting structure further comprising
a third sealing member for sealing a space between the first connector and the second connector by being sandwiched by both an outer peripheral surface of the protrusion and an inner peripheral surface of the recess while in close contact with each of the outer peripheral surface of the protrusion and the inner peripheral surface of the recess.

8. The connector connecting structure according to claim 4, wherein
the first connector includes a protrusion that enters the second connector, and the second connector includes a recess for receiving the protrusion,
the connector connecting structure further comprising
a third sealing member for sealing a space between the first connector and the second connector by being sandwiched by both an outer peripheral surface of the protrusion and an inner peripheral surface of the recess while in close contact with each of the outer peripheral surface of the protrusion and the inner peripheral surface of the recess.

9. The connector connecting structure according to claim 1, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

10. The connector connecting structure according to claim 2, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

11. The connector connecting structure according to claim 3, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

12. The connector connecting structure according to claim 4, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

13. The connector connecting structure according to claim 5, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

14. The connector connecting structure according to claim 6, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

15. The connector connecting structure according to claim 7, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

16. The connector connecting structure according to claim 8, further comprising
a fourth sealing member arranged sandwiched by both the first connector and the second connector while in close contact with each of the first and second connectors so as to surround a terminal connection region where the first terminal and the second terminal are connected at a boundary of the first connector and the second connector which are connected with each other, and when liquid inside the liquid-filled case passes through at least one terminal of the first connector and the second connector and flows to the terminal connection region, blocking the liquid from progressing to an outer peripheral surface of the first connector.

17. The connector connecting structure according to claim 1, wherein
the first connector is provided with a blocking rib for blocking, when liquid inside the liquid-filled case passes through at least one terminal of the first connector and the second connector and flows to a terminal connection region at a boundary of the first connector and the second connector which are connected with each other, the liquid from progressing to an outer peripheral surface of the first connector so as to surround the terminal connection region.

18. The connector connecting structure according to claim 1, wherein
the second connector is fixed to a case of the external device.

19. The connector connecting structure according to claim 1, wherein
the first terminal of the first connector is female type, and the second terminal of the second connector is male type.
